(19) United States
(12) Patent Application Publication
(10) Pub. No.: US 2018/0246673 A1
(43) Pub. Date: Aug. 30, 2018

(54) METHOD AND STORAGE SYSTEM FOR STORING A MULTIPLICITY OF DATA UNITS

(71) Applicant: Siemens Aktiengesellschaft, München (DE)

(72) Inventor: Jan-Gregor Fischer, Zorneding (DE)

(21) Appl. No.: 15/904,611

(22) Filed: Feb. 26, 2018

(30) Foreign Application Priority Data
Feb. 28, 2017 (DE) 102017203239.1

(51) Int. Cl. G06F 3/06

(52) U.S. Cl. CPC G06F 3/0659; G06F 3/067; G06F 3/0653; G06F 3/0604

(57) ABSTRACT

A method for storing data units from a data source in a selectable storage device from a storage system, wherein a data unit attribute is allocated to each data unit and a storage attribute is allocated to each storage device, comprising the following steps: checking and adapting the data unit attributes at specified times during an operation of the storage devices; evaluating the data unit attributes and the storage attributes for generating storage system state data; and, for each data unit, selecting a storage device depending on the allocated data unit attributes, at least a selection of the storage attributes and the storage system state data, and storing the respective data unit) in the selected storage device; wherein the data unit attributes and/or storage attributes comprise information relating to a selection and storage of data units at previous times.

### CROSS-REFERENCE TO RELATED APPLICATIONS

This application claims priority to German application No. 102017203239.1 having a filing date of Feb. 28, 2017, the entire contents of which is hereby incorporated by reference.

### FIELD OF TECHNOLOGY

The following relates to a method and a storage system for storing a multiplicity of data units, and a computer program product (non-transitory computer readable storage medium having instructions, which when executed by a processor, perform actions) to carry out the method.

### BACKGROUND

The storage of large data volumes is required today, particularly in industrial applications. A monitoring system, for example, which monitors a quality of a manufactured product comprises a plurality of sensors which generate a large volume of data or data units to be stored. These data are intended, as far as possible, to be stored optimally in such a way that data can be accessed quickly and in a secure manner. At the same time, the data should be stored economically in terms of storage costs.

The document by J. Seeger et al, entitled “DB2 V10.1 Multi-temperature Data Management Recommendations”, IBM, April 2012, describes a temperature-based storage of data in storage devices with different quality characteristics. With temperature-based storage of this type, the data are categorized into different temperature classes according to age. The most recent data, i.e. data which have been generated only a short time ago, are categorized as “hot” data, and old data, i.e. data which have been generated some time ago, are categorized as “cold data”. In temperature-based data storage, it is assumed that hot data are accessed more frequently than cold data. Hot data are therefore stored on particularly powerful and reliable data storage devices, whereas cold data are stored on less powerful and less expensive data storage devices.

### SUMMARY

An aspect relates to providing an improved method for storing data units in different storage devices.

A further aspect consists or comprises in providing a computer program product to carry out the method for storing a multiplicity of data units, and a storage system.

Accordingly, a method for storing a multiplicity of data units from a data source or from a plurality of data sources in a selectable storage device from a storage system of different storage devices is proposed, wherein at least one data unit attribute is allocated to each data unit and at least one storage attribute is allocated to each storage device. The method comprises:

checking and adapting the data unit attributes at specified times or continuously during an operation of the storage devices;

evaluating the data unit attributes and the storage attributes to generate storage system state data; and

for each data unit, selecting a storage device depending on the allocated data unit attributes, at least a selection of the storage attributes and the storage system state data, and storing the respective data unit in the selected storage device;

wherein the data unit attributes and/or storage attributes comprise information relating to a selection and storage of data units at previous times.

According to one embodiment, a storage system with different storage devices is proposed which is configured to store a multiplicity of data units from one data source or from a plurality of data sources in a selectable storage device from the different storage devices, wherein at least one data unit attribute is allocated to each data unit and at least one storage attribute is allocated to each storage device. The storage system comprises:

a processing device which is configured to check and adapt the data unit attributes at specified times or continuously during an operation of the storage devices;

an evaluation device which is configured to evaluate the data unit attributes and the storage attributes and to generate storage system state data; and

a selection device which selects a storage device for each data unit depending on the allocated data unit attributes, at least a selection of the storage attributes and the storage system state data, and stores the respective data unit in the selected storage device;

wherein the data unit attributes and/or storage attributes comprise information relating to a selection and storage of data units at previous times.

According to a further embodiment, the storage system is configured to carry out the method described above and below.

The data source and the storage system are, in particular, part of an automation system for industrial applications. The data source may comprise one or more sensors which record or generate sensor data, for example temperature, moisture or pressure, as data units and output them once or repeatedly to the storage system. The data source may also be a production control system, a product life cycle management system, an SAP system, an SAP database and information from internal and/or external services, for example from a weather forecast platform. The data units may comprise image, sound or text data. The data units may be designed as tables. A data unit embodies, for example, physically or electrically recordable information as a datum. It can be said that the data unit is embodied as a data packet.

The data unit attribute which is allocated to each data unit comprises, for example, characteristics which are specific to the data unit and/or comprise information for identifying the data unit. The data unit attribute may indicate, for example, an age of the data unit, a size of the data unit and/or a frequency of an access to the data unit.

Storage devices are generally understood to mean storage technologies. These may comprise storage devices such as RAM disks, solid-state disks, hard disk drives (HDD) or tape storage devices, as well as data storage services such as data warehouses, Hadoop systems, RDF triple stores, cloud storage resources, domain servers or network-attached storage (NAS storage). The technical storage devices differ from one another, particularly in terms of quality and cost characteristics.

These storage-specific characteristics can be allocated to each storage unit as the storage attribute. These characteristics comprise, for example, the storage capacity of the storage device which indicates a maximum data volume or original data volume storable in the storage device, a data transmission rate which indicates a data volume which can be accessed in a specific time interval, and/or a reliability which indicates a capability of operating correctly over a specific time period under specific conditions. The characteristic or the storage attribute may furthermore comprise information relating to the IT security of the storage device, and/or relating to storage costs which indicate costs of a storage in the storage device.

The specified times are specified, for example, by clock times and/or, as explained below, by an occurrence of a specified event in connection with the storage system. It can be determined, for example, that a specified time occurs if one of the storage devices is utilized up to a specific value, for example 80%.

The operation of the storage devices indicates, in particular, a state during which data units are stored in the storage devices of the storage system, and/or in which the data stored in the storage devices are accessed. “In operation” may mean that data or corresponding information is/are retained in retrievable, in particular electronically retrievable, form. This may occur in the form of storage cells.

The checking and adaptation of the data unit attributes at the specified times and/or events may concern not only the data unit attributes of data units to be stored, but also the data unit attributes of already stored data units. The access frequency of a specific, already stored data unit may be increased, for example, if it is intended to retrieve this data unit more frequently in future.

The data unit attributes may be updated continuously during the operation of the storage devices, particularly in order to monitor a storage state of the respective data unit.

Storage system state data may indicate a state of the entire storage system, for example a system utilization, but also an energy consumption, a geographical distribution of storage devices or the like.

One storage device is selected from the storage system for each data unit, in particular for all data units. In particular, the corresponding storage device for storing the data unit is selected for each data unit to be stored, for example for data units which have just been received from the data source and have not yet been stored in the storage system.

A new storage unit can also be selected for data units already stored in a current storage device, taking account of current data unit attributes, storage attributes and storage system state data. If this new storage device does not match the current storage device, a storage transfer or a reallocation of the data unit can take place. According to a further embodiment, the method thus comprises a storage transfer of a data unit from the selected storage device into a new selected storage device. Here, the storage transfer of a data unit from the selected storage device into the new selected storage device comprises a temporary copying of the data unit from the selected storage device into the new selected storage device, and a subsequent deletion of the data unit from the selected storage device. A storage space of the selected storage device which has become free through deletion of the data unit can then be used to store further data units.

The selection of the storage device therefore corresponds, in particular, to a decision regarding an allocation or reallocation of the respective data units.

The selection, in particular using the evaluation device, is carried out, for example, on the basis of an algorithm which processes the data unit attributes, at least a selection of the storage attributes, and the storage system state data. Machine-learning methods, for example neural networks or a regression analysis, can be used as algorithms. These will be described below.

At least some of the data unit attributes and/or storage attributes comprise information relating to a selection and storage of data units at previous times. Here, previous times are times which are earlier than a current time. The data unit attributes may comprise, for example, a history of the data unit. The information relating to a selection and storage of data units at previous times may be derived directly from data unit attributes and/or storage attributes from previous times, or may be learnt, for example, by means of pattern recognitions or neural networks.

In particular, the storage device which is determined as the optimum storage device in terms of the data unit attributes, particularly in terms of the access frequency, is selected for each data unit.

An optimized, application-specific data storage is enabled given that the proposed method takes account of both current and past storage characteristics (storage attributes) data characteristics (data unit attributes) and system characteristics (system state data). The data units may be stored, in particular, in such a way that required data units can be accessed quickly. At the same time, storage costs are optimized since the unnecessary storage of large numbers of data units in expensive storage devices can be avoided.

According to a further embodiment, a time interval between consecutive specified times for checking and adapting the data unit attributes is constant and/or is determined by a specified event which is defined by a specified storage operating state of the storage system.

If the time interval between consecutive specified times is constant, the data unit attributes are checked and adapted periodically, for example every hour.

The specified event is a trigger event which brings about a checking and adaptation of the data unit attributes. Examples of a trigger event would be an exceeding of a predetermined utilization of a storage device, a receipt of a data unit from a predetermined data source, and/or a change of the user who accesses the stored data units.

According to a further embodiment, the data unit attribute allocated to the data unit comprises at least one of the following attributes:

a data unit generation time at which the data unit was generated,

a frequency of an access to the data unit over a predetermined time period,

a current and/or previous storage location of the data unit,

a current and/or previous user accessing the data unit; or

a current and/or previous categorization into one or more predetermined temperature classes for the data unit.

A (temporary) data unit attribute which comprises, for example, the data unit generation time can be allocated to the data unit when it is generated or when it is received in the storage system. In addition, a data unit generation location which indicates a generation location or a generation source of the data unit can also be allocated to the data unit.

On this basis or independently therefrom, one of the listed attributes can be added to the existing data unit attribute during the checking and adaptation of the data unit attributes at the specified times. As a result, the data unit attribute can reflect a history of the data unit. The data unit attribute can be updated continuously during the operation of the storage devices.

The current storage location of the data unit indicates the storage device in which the data unit is currently stored. The previous storage location of the data unit indicates the storage device or the storage devices in which the data unit was stored in the past.

The respective data units can be categorized into a plurality of temperature classes. Temperature classes comprise, in particular, the classes “cold”, “warm” and “hot”, and indicate a priority of the data units. The “cold” data may have a lower priority than the “warm” data, which in turn have a lower priority than the “hot” data. Data units can be stored in different storage devices depending on the temperature. Particularly fast storage devices are suitable, for example, for storing “hot” data only. A fast access to high-priority data can be enabled by a temperature-based storage of this type, whereas lower-priority data can be stored on slower but less expensive storage units.

The information relating to the current and/or previous user accessing the data unit can be used in the selection of the storage device in such a way that storage and retrieval preferences of the respective users are taken into account. The data unit retrieved by a user can also be given a priority which corresponds to a weighting of the user and can serve to categorize the data unit into one of the temperature classes.

According to a further embodiment, the data unit attribute indicates at least one of the specified times for checking and adapting the data unit attributes.

According to a further embodiment, the storage attribute allocated to the storage device comprises at least one of the following attributes:

a data transmission rate of the storage device;

a latency of the storage device;

a fluctuation of the latency;

a current storage space and/or an original storage space available in the storage device; or

a different system quality of the storage device, such as, for example, a reliability, availability, information security, scalability, fault tolerance, resilience, manageability, testability, cost information, etc.;

one or more additional functions which the storage device offers over and above the actual storage of information, such as, for example, an integrated data analysis function.

The storage attribute can be allocated to a respective storage device, or can be adapted multiple times, in particular regularly during the operation of the storage devices. The storage attribute indicates, in particular, a quality characteristic of the respective storage device.

In particular, according to a further embodiment, the method comprises a checking and adaptation of the storage attributes at a plurality of times and/or events during the operation of the storage devices.

According to a further embodiment, the storage system data comprise at least the following data:

metadata relating to a current and/or previous utilization of the storage system;

metadata relating to the current and/or previous storage of the data units; and/or

metadata relating to the current and/or previous storage transfer of the data units.

Metadata refer here to data which contain information relating to at least some of the data unit attributes and/or storage attributes without themselves containing the data unit attributes and/or storage system data.

The metadata relating to the current and/or previous utilization of the storage system indicate, for example as a percentage value, how much storage space in the entire storage system is used or was used at a time in the past.

The metadata relating to the current and/or previous storage or storage transfer of the data units may comprise a mapping of the stored data units in the respective storage devices. They may furthermore contain information relating to allocation or reallocation decisions which were made in order to select the storage devices for the respective data units. They may furthermore contain information relating to failures of the storage system.

According to a further embodiment, the checking and adaptation of the data unit attributes are carried out at the specified time, taking account of at least a selection of earlier data unit attributes, storage attributes and storage system state data.

In particular, decisions regarding the selection of the storage unit are made taking into account previous decisions regarding the selection of the storage unit.

According to a further embodiment, the method furthermore comprises:

modelling a future storage system state depending on the current and/or previous allocated data unit attributes, at least a selection of the current and/or previous storage attributes and the current and/or previous storage system state data.

In this respect, improved storage unit attributes and/or storage attributes are modelled in embodiments and the current storage unit attributes and/or storage attributes are replaced by the improved attributes.

A planning of the allocation and reallocation steps can thus be mathematically optimized, in particular taking account of applicable constraints. The modelling may, in particular, increase a reliability of the storage system because a user, for example, can thus be informed of a potential failure of the storage system or of a full utilization of a storage unit.

According to a further embodiment, the selection of the storage device furthermore comprises a processing of the allocated data unit attributes, at least the selection of the storage attributes and the storage system state data by means of a method which uses statistical models, semantic models, logic-based or rule-based information systems, neural networks, regression models or decision trees.

Any methods from machine learning can generally be used to select the storage device. The allocation of attributes and/or the selection of the storage devices preferably comprises the use of a machine-learning method.

A neural networking, for example, using previous data unit attributes, storage attributes and storage system state data can be created or learnt. The learnt neural network can be used to make decisions regarding the selection of the storage device.

An anticipatory (re-)allocation of the data units, and also a trend formation of the storage system and the user behavior, can be determined using machine learning and statistics.

A regression analysis can be used to determine relationships between different events or between data unit attributes, sensor attributes and storage system state data.

Decision trees or rule-based systems which represent successive decisions regarding the selection of the storage devices can also be used. In particular, it can be recognized how specific situations or decisions have arisen in order to improve the method.

Semantic models and logic-based systems can be used which represent the causally, temporally or spatially logical relationships for the decision regarding the selection of the storage devices.

Statistical models which represent the probability-based decisions regarding the selection of the storage devices can also be used.

In particular, a failure/cause analysis can also be carried out in order to recognize which events, in particular which data unit attributes and sensor attributes, have resulted in specific decisions regarding the selection of the storage devices.

The respective selection mechanism which is used for selecting the storage devices can carry on learning continuously and thus continuously improve the decisions regarding the selection of the storage devices.

According to a further embodiment, the storage devices comprise RAM disks, solid-state disks, hard disk drives, tape storage devices, in-memory databases, time series databases, data warehouses, relational, object-oriented and NoSQL repositories, Hadoop systems, graph-oriented databases, RDF triple stores, cloud storage resources, domain servers and/or network-attached storage devices.

The Hadoop system or Hadoop file system, also referred to as the Hadoop Distributed File System (HDFS), is a system for storing very large data volumes on the file systems of a plurality of computers (nodes).

The in-memory database is, in particular, a data management system which uses the RAM memory of a computer as a data memory. The time series database is a system which is suitable, in particular, for storing time series. The graph-oriented database can use graphs to represent and store highly networked information.

According to a further embodiment, a computer program product is proposed with a program which instigates the performance of the above method on a program-controlled device. Particularly the processing device, the evaluation device and the selection device can be implemented as program-controlled devices.

A computer program product (non-transitory computer readable storage medium having instructions, which when executed by a processor, perform actions), such as e.g. a computer program means, may be provided or supplied, for example, as a storage medium, such as e.g. a memory card, USB stick, CD-ROM, DVD, or in the form of a downloadable file from a server in a network. This can be effected, for example, in a wireless communication network through the transmission of a corresponding file with the computer program product or the computer program means.

The embodiments and features described for the proposed method apply accordingly to the proposed storage system.

Further possible implementations of embodiments of the invention also comprise combinations, not explicitly specified, of features or embodiments described above or below in relation to the example embodiments. The person skilled in the art will also add individual aspects as improvements or supplements to the respective basic form of embodiments of the invention.

### BRIEF DESCRIPTION

Some of the embodiments will be described in detail, with reference to the following figures, wherein like designations denote like members, wherein:

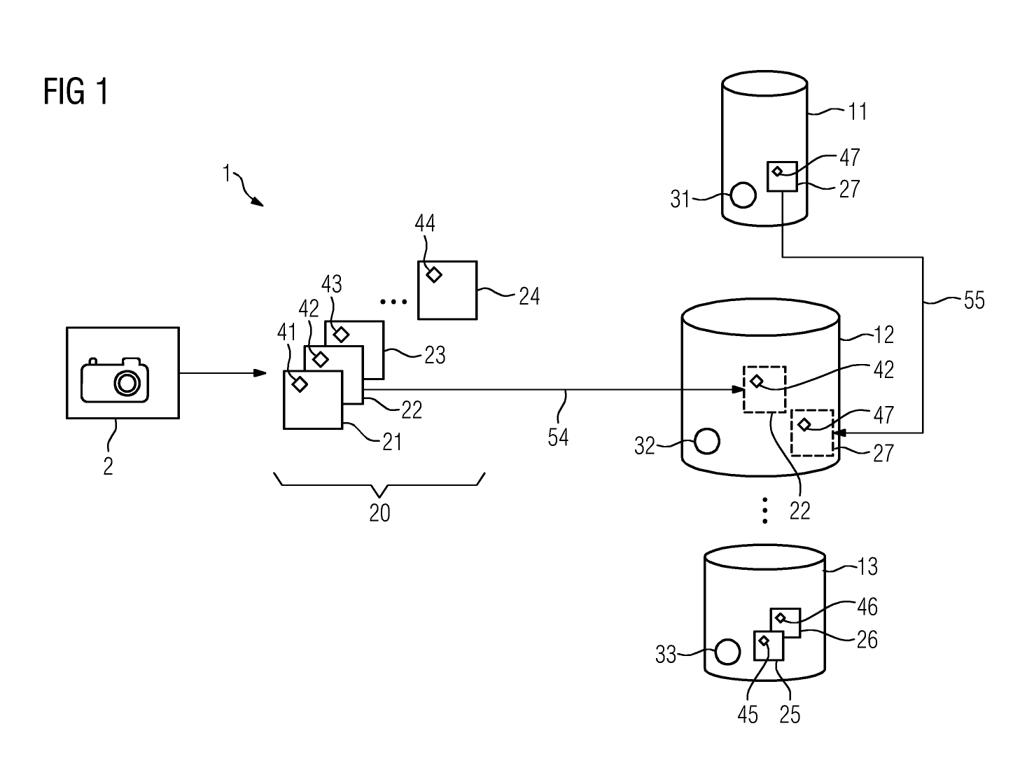

FIG. 1 shows a storage system according to a first embodiment;

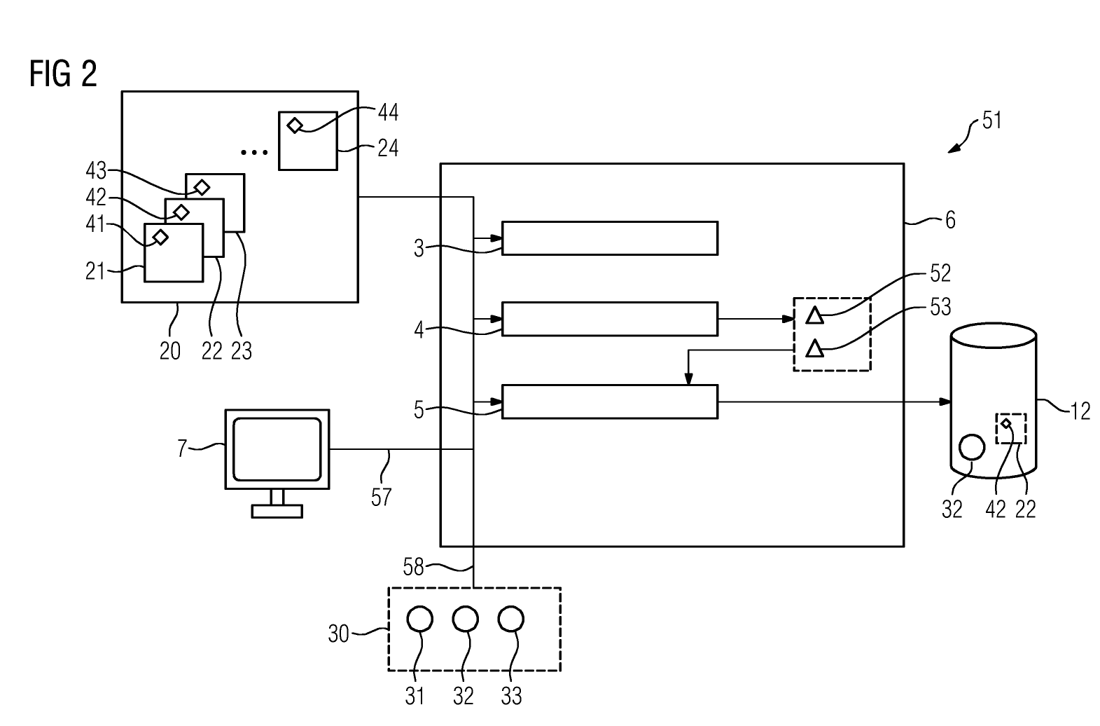

FIG. 2 shows a storage system according to a second embodiment; and

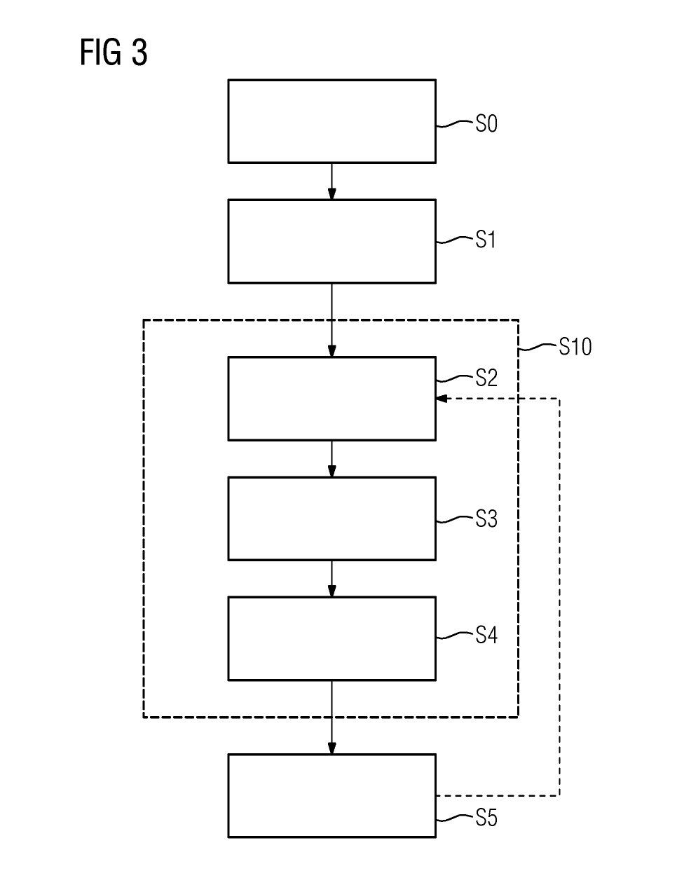

FIG. 3 shows a sequence of a method for storing data units according to a first embodiment.

In the figures, identical or functionally identical elements are denoted by the same reference numbers, unless otherwise indicated.

### DETAILED DESCRIPTION

FIG. 1 shows a storage system 1 according to a first embodiment. Here, the storage system 1 is a storage system made up of three storage devices 11-13. The storage devices 11-13 are configured to store a multiplicity 20 of data units 21-24, which are received by the storage system 1 from a data source 2.

Here, the data source 2 is a camera which photographs a manufactured product at regular intervals for monitoring an industrial product manufacture. The camera can be regarded as a sensor device. The camera thus creates the multiplicity 20 of image data 21-24 as the data units which are transmitted to the storage system 1 as image units 21-24 to be stored.

An image attribute 41-44 is allocated as a data unit attribute to each of the image units 21-24 to be stored. The image attributes 41-44 are shown in FIG. 1 as diamonds. Each of the image attributes 41-44 comprises information relating to the respective image units 21-24. Here, the image attributes 41-44 in each case comprise, in particular, information relating to the time when the respective image units 21-24 were created, and a frequency of an expected access to the respective image units 21-24 over a predetermined period, for example in the next week.

The storage devices 11-13 have different characteristics, in particular different storage capacities, access speeds and data transmission rates. In the embodiment of the storage system 1 shown in FIG. 1, the storage device 11 is a Hadoop system which is developed by the manufacturer Apache Software Foundation and has a plurality of nodes which are distributed in a computer cluster (not shown), for storing the image units 21-27. The Hadoop-System 11 is balanced in terms of costs and quality.

Here, the storage device 12 is a very expensive, but very fast, in-memory database system (IMDB). In this embodiment, image units which have a high weighting or priority are stored mainly in the IMDB 12.

Here, the storage device 13 is furthermore a low-cost and very slow cloud-based archiving system. Image units with a very low priority are stored mainly in the storage device 13.

On the whole, the storage device 12 provides a faster and more expensive storage of the image units 21-27 than the storage device 11, which in turn provides a faster and more expensive storage of the image units 21-27 than the storage device 13.

A storage attribute 31-33 is allocated to each storage unit 11-13. The storage attributes 31-33 are shown in FIG. 1 as circles. Each storage attribute 31-33 contains information which describes the respective storage units 11-13. Each storage attribute 31-33 contains, for example, the data transmission rate and the storage capacity of the respective storage unit. Each storage attribute 31-33 furthermore contains not only a current storage space available in the respective storage unit 11-13, but also a storage space available in the past in the respective storage unit 11-13.

Data units 25-27 are already stored in the storage units 11 and 13. Here, these stored data units 25-27 are image units which have been generated by the camera 2. Alternatively, the stored data units 25-27 could also be data units which have been generated by a different data source, for example by a temperature sensor. Each of the stored image units 25-27 comprises an image attribute 45-47 which is shown by a diamond. The image attributes 45-47 comprise similar information to the image attributes 41-44.

The storage system 1 shown in FIG. 1 is configured, in particular, in such a way that it can carry out a method for storing the multiplicity 20 of image units 21-24. A method of this type is shown, for example in FIG. 3, which shows a sequence of a method for storing data units according to a first embodiment. An implementation of the method from FIG. 3 is described below with the storage system 1 shown in FIG. 1.

In a preparatory step S0, the storage units 11-13 with allocated storage attributes 31-33 are provided as part of the storage system 1. In a step S1, the image units 21-24 with allocated image attributes 41-44 are provided by the camera 2 and are received by the storage system 1.

At a specified time at which, for example, the storage system 1 receives the image unit 21, the image attributes 41-47 are checked and adapted in a step S2. The frequency of the access to the respective image units 21-24 is adapted, for example, over the predetermined period. The adaptation can be carried out taking account of inputs of a user of the storage system 1. Additionally or alternatively, the adaptation can be carried out on the basis of a specified model or a model created by the storage system 1. In particular, the image attribute 47 which is allocated to the image unit 27 is adapted in the storage system 1 shown in FIG. 1. In the first embodiment of the storage system 1, the access frequency of the image unit 27 is increased, so that the priority of the image unit 27 is very high.

In a step S3, the updated image attributes 42-44 and 45-47 and the storage attributes 31-33 are evaluated in order to generate storage system state data.

In a step S4, the storage system 1 selects the fastest storage unit, i.e. the storage unit 12 from the storage units 11-13, for the image unit 22, which has a particularly high priority, in order to store the image unit 22 therein. The selection of the storage device 12 in which the image unit 22 is intended to be stored is carried out taking account of at least the image attribute 42 which is allocated to the image unit 22, and a selection of the storage attributes 31-33.

Step S4 is furthermore carried out for the remaining image units 21 and 23-27 also.

In particular, a new, faster storage device, i.e. the storage device 12, is selected for the image unit 47 already stored in the storage device 11, for storing the image unit 47 taking account of the updated image attribute 47.

After the storage devices 11-13 have been selected for storing the respective image units 21-27, the storage system 1 stores the image units 21-27 in the respective selected storage devices 11-13 in a step S5. In particular, the image unit 22 is stored in the selected fast storage device 12. This storage is shown by the arrow 54 in FIG. 1. The image unit 22 stored in the storage device 12 is shown by broken lines.

The image unit 27 is furthermore transferred for storage into the selected fast storage device 12. This storage transfer is shown by the arrow 55 in FIG. 1. The image unit 27 stored in the storage device 12 is shown by broken lines.

Step S5 is furthermore carried out for the remaining image units 21 and 23-26 also (not shown). If a storage device 11-13 in which the image attribute 21-27 is already stored is selected in step S4 for storing an image attribute 21-27, no storage transfer of the image attribute 21-27 takes place.

Steps S2 to S5 are explained in more detail below.

FIG. 2 shows a storage system 51 according to a second embodiment. In this embodiment also, the storage system 51 comprises the different storage devices 11-13 described above, and additionally comprises a decision mechanism 6 and a user interface 7.

The function of the storage system 51 is identical to the function of the storage system 1 from the first embodiment, with a number of exceptions described below. In particular, the storage system 51 is configured to carry out the method described in FIG. 3 for storing the multiplicity 20 of image units 21-24.

The storage devices 11-13 with the storage attributes 31-33 and the image units 21-24 are provided in the preparatory steps S0 and S1.

The decision mechanism 6 is implemented by a processor which is configured to carry out a method, in particular a computer program, for storing the image units 21-24. The corresponding computer program causes the processor 6, for example, to carry out a method as shown in FIG. 3.

The processor 6 contains the provided multiplicity 20 of image units 21-24, the image attributes 41-44 and a multiplicity 30 of storage attributes 31-33 as input data.

The processor 6 implements the processing device 3 which is configured to carry out step S2, in particular to check and adapt the image attributes 41-44. The processing device 3 adapts the image attributes 41-44 using a model which is communicated by a user via the user interface 7 to the processor 6, in particular to the processing device 3. A simulation model, for example, which determines a predicted access probability in a specific subsequent time period is used for the attribute adaptation.

Here, the user interface 7 is a computer which can communicate via a cable connection 57 with the processor 6. The computer 7 can be used by the user to retrieve the image units 21-24.

The image attributes 41-44 updated by the processing device 3 are transmitted via an internal bus 58 to the evaluation device 4 of the processor 6. The evaluation device 4 contains the storage attributes 31-33 of the storage devices 11-13 as further input data.

Before being input into the evaluation device, the storage attributes 31-33 can also be checked and adapted by the processing device in exactly the same way as the image attributes 41-44.

The evaluation device 3 is configured to carry out step S3 of the method described in FIG. 3, in particular to evaluate the updated image attributes 41-44 and the storage attributes 31-33 in order to generate system state data 52, 53 as storage system state data.

The storage system state data 52, 53 are shown as triangles in FIG. 2, and comprise, in particular, a current storage state of the entire storage system 1, and information relating to failures of the storage system 1.

The selection device 5 is configured to carry out steps S4 and S5, in particular to select one of the storage devices 11-13 for each data unit 21-24. Here, the selection device receives the updated image attributes 41-44, the storage attributes 31-33 and the storage system state data 52, 53 as input data.

The selection device 5 makes a decision regarding the storage device 11-13 in which each data unit 21-24 is to be stored. The decision can be made using a learnt neural network, which will also be explained below.

If the image units 21-24 are image units to be stored which have just been received from the camera 2 (not shown), they are stored in the respective storage devices 11-13 selected by the selection device 4.

If the image units 21-24 are image units already stored in the storage devices 11-13, the image units 21-24 are transferred for storage if a new storage device 11-13 is selected by the selection device 4 for storing the image units 21-24.

Further aspects of FIG. 3, which shows a sequence of a method for storing data units according to the first embodiment, are described here.

Steps S0 to S5 have already been explained with reference to the embodiments shown in FIGS. 1 and 2.

The broken arrow which leads from step S5 to step S2 indicates that steps S2 to S5 are repeated multiple times. Step S2 is in fact repeated after step S5 at each of the predetermined times, for example every five minutes. Steps S3 to S5 are consequently also carried out again each time.

A plurality of passes of a step S10, which comprises steps S2 to S4, can be used for the learning of a neural network. The neural network learns, in particular, which decisions are made regarding the selection of the storage devices 11-13 and under which constraints, which are indicated by the image attributes 41-47, storage unit attributes 31-33 and system storage state data 52, 53. After a plurality of passes of step S10, the neural network can already be used to select the storage devices 11-13 for each image unit 21-27 in step S4. The neural network can continue to learn with each additional pass of step S10.

Although embodiments of the present invention have been described on the basis of the above example embodiments, it is modifiable in a variety of ways. Any given data source, for example, can be used to generate the data units. The storage system also does not have to comprise the described selection of storage devices. In particular, the number and type of storage devices can be randomly chosen. The data unit attributes and storage attributes may comprise further information as constraints. Along with the explicitly specified neural network, other intelligent machine-learning algorithms are conceivable for performing the storage device (re-)allocation.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for storing a multiplicity of data units from a data source in a selectable storage device from a storage system of different storage devices, wherein at least one data unit attribute is allocated to each data unit and at least one storage attribute is allocated to each storage device, comprising:
checking and adapting the data unit attributes at specified times during an operation of the storage devices;
evaluating the data unit attributes and the storage attributes for generating storage system state data; and
for each data unit, selecting a storage device depending on the allocated data unit attributes, at least a selection of the storage attributes and the storage system state data and storing the respective data unit in the selected storage device;
wherein at least one of the data unit attributes and storage attributes comprise information relating to a selection and storage of data units at previous times.

2. The method as claimed in claim 1, wherein a time interval between consecutive specified times for checking and adapting the data unit attributes is at least one of constant and is determined by a specified event which is defined by a specified storage operating state of the storage system.

3. The method as claimed in claim 1, furthermore comprising:
storage transfer of a data unit from the selected storage device into a new selected storage device.

4. The method as claimed in claim 1, wherein the data unit attribute allocated to the data unit comprises at least one of the following attributes:
a data unit generation time at which the data unit was generated,
a frequency of an access to the data unit over a predetermined time period,
a current and/or previous storage location of the data unit,
a current and/or previous user accessing the data unit; and
a current and/or previous categorization into one or more predetermined temperature classes for the data unit.

5. The method as claimed in claim 1, wherein the data unit attribute specifies at least one of the specified times for checking and adapting the data unit attributes.

6. The method as claimed in claim 1, wherein the storage attribute allocated to the storage device comprises at least one of the following attributes:
a data transmission rate of the storage device;
a latency of the storage device;
a fluctuation of the latency;
a current storage space and/or an original storage space available in the storage device; or
a reliability of the storage device.

7. The method as claimed in claim 1, wherein the storage system state data comprise at least the following data:
metadata relating to one of a current and a previous utilization of the storage system;
metadata relating to one of the current and the previous storage of the data units; and/or
metadata relating to the current and/or previous storage transfer of the data units.

8. The method as claimed in claim 1, wherein the checking and adaptation of the data unit attributes are carried out at the specified time, taking account of at least a selection of earlier data unit attributes, storage attributes and storage system state data.

9. The method as claimed in claim 1, furthermore comprising:
modelling a future storage system state depending on the current and/or previous allocated data unit attributes, at least a selection of the current and/or previous storage attributes and the current and/or previous storage system state data.

10. The method as claimed in claim 1, wherein the data source is a sensor which once or repeatedly generates sensor data as data units.

11. The method as claimed in claim 1, wherein the selection of the storage device comprises:
processing the allocated data unit attributes, at least the selection of storage attributes and the storage system state data by means of a method which uses statistical models, semantic models, logic-based or rule-based information systems, neural networks, regression models or decision trees.

12. The method as claimed in claim 1, wherein the storage devices comprise RAM disks, solid-state disks, hard disk drives, tape storage devices, data warehouses, in-memory databases, time series databases, relational, object-oriented and NoSQL repositories, Hadoop systems, graph-oriented databases, RDF triple stores, cloud storage resources, domain servers and/or network-attached storage devices.

13. A computer program product comprising a computer readable hardware storage device having computer readable program code stored therein, said program code executable by a processor of a computer system to implement a method with a program which instigates the performance of the method as claimed in claim 1 on a program-controlled device.

14. A storage system with different storage devices, which is configured to store a multiplicity of data units from a data source in a selectable storage device from the different storage devices, wherein at least one data unit attribute is allocated to each data unit and at least one storage attribute is allocated to each storage device, comprising:
a processing device which is configured to check and adapt the data unit attributes at specified times during an operation of the storage devices;
an evaluation device which is configured to evaluate the data unit attributes and the storage attributes and to generate storage system state data; and
a selection device which selects a storage device for each data unit depending on the allocated data unit attributes, at least a selection of the storage attributes and the storage system state data, and stores the respective data unit in the selected storage device;
wherein the data unit attributes and/or storage attributes comprise information relating to a selection and storage of data units at previous times.

15. The storage system as claimed in claim 14, which is configured to be implemented in such a way that it carries out the method for storing a multiplicity of data units from a data source in a selectable storage device from a storage system of different storage devices, wherein at least one data unit attribute is allocated to each data unit and at least one storage attribute is allocated to each storage device, comprising:
checking and adapting the data unit attributes at specified times during an operation of the storage devices;
evaluating the data unit attributes and the storage attributes for generating storage system state data; and
for each data unit, selecting a storage device depending on the allocated data unit attributes, at least a selection of the storage attributes and the storage system state data and storing the respective data unit in the selected storage device;
wherein at least one of the data unit attributes and storage attributes comprise information relating to a selection and storage of data units at previous times.
